(19) United States
(12) Patent Application Publication
(10) Pub. No.: US 2004/0221299 A1
(43) Pub. Date: Nov. 4, 2004

(54) Method and apparatus for developing interface protocols for peer to peer applications

(76) Inventors: Simon Gibbs, San Jose, CA (US); Ravi Gauba, Fremont, CA (US); Jeff Liu, Fremont, CA (US); Sidney Wang, Pleasanton, CA (US)

Correspondence Address: Valley Oak Law, 5655 Silver Creek Valley Road, #106, San Jose, CA, 95138, US

(21) Appl. No.: 10/403,782

(22) Filed: Mar. 31, 2003

(51) Int. Cl. G06F 9/00

(52) U.S. Cl. 719/331; 719/328

(57) ABSTRACT

The invention illustrates a system and method of providing a plurality of protocols under a common set of peer to peer protocols. In one embodiment, the system and method comprises: communicating with a peer device via an interface framework; and transmitting information between a first application on the peer device via a first plug-in wherein the first plug-in is compatible with the interface framework. In another embodiment, the system and method comprises: an interface configured for communicating with the peer device; and a plug-in configured for communicating with the interface and an application, wherein the plug-in is configured to translate requests from the application into a peer device request that is understood by the peer device.

### FIELD OF THE INVENTION

The present invention relates generally to providing peer to peer interfaces and, more particularly, to providing protocols under a common set of peer to peer interfaces.

### BACKGROUND OF THE INVENTION

There have been many advances in consumer electronics devices. Consumer electronics devices may include devices such as cellular telephones, pagers, digital cameras, personal digital assistants (PDAs), remote controls, and the like.

In addition to becoming smaller, an increasing number of consumer electronic devices are network enabled and capable of accessing Web services through the Internet operated by the device vendor and/or third parties. With their ability to access the Internet directly, these consumer electronic devices will no longer rely on the traditional personal computer as intermediary device.

Once consumer electronics devices have their own network interfaces, in addition to communicating to other devices as a client from a client-server relationship, these interfaces can also be used for device-to-device, so-called peer to peer, communication.

Due to a variety of peer-to-peer protocols which can be customized for particular consumer electronics devices, there are challenges associated with offering applications which can be universally utilized by consumer electronic devices.

### SUMMARY OF THE INVENTION

The invention illustrates a system and method of providing a plurality of protocols under a common set of peer to peer protocols. In one embodiment, the system and method comprises: communicating with a peer device via an interface framework; and transmitting information between a first application on the peer device via a first plug-in wherein the first plug-in is compatible with the interface framework. In another embodiment, the system and method comprises: an interface configured for communicating with the peer device; and a plug-in configured for communicating with the interface and an application, wherein the plug-in is configured to translate requests from the application into a peer device request that is understood by the peer device.

Other aspects and advantages of the invention will become apparent from the following detailed description, taken in conjunction with the accompanying drawings, illustrated by way of example of the principles of the invention.

### BRIEF DESCRIPTION OF THE DRAWINGS

The accompanying drawings, which are incorporated in and constitute a part of this specification, illustrate one embodiment of the invention and, together with the description, explain one embodiment of the invention. In the drawings,

FIG. 1A is a diagram illustrating an environment within which the invention may be implemented.

FIG. 1B is a diagram illustrating an environment within which the invention may be implemented.

FIG. 2 is a simplified block diagram illustrating one embodiment in which the invention may be implemented.

FIG. 3 is a simplified block diagram illustrating an interface framework, consistent with one embodiment of the invention.

FIG. 4 is a simplified block diagram illustrating a system overview, consistent with one embodiment of the invention.

FIG. 5 is a hierarchy diagram illustrating a sample interface hierarchy, consistent with one embodiment of the invention.

FIG. 6 is a flow diagram consistent with one embodiment of the invention.

### DETAILED DESCRIPTION

The following detailed description of the invention refers to the accompanying drawings. The detailed description does not limit the invention. Instead, the scope of the invention is defined by the appended claims and equivalents.

The invention includes methods and apparatus for developing seamless and universal interfaces for consumer electronic devices. The invention also includes methods and apparatus for enabling a variety of different interfaces from various consumer electronic devices to communicate with each other. The invention also includes methods and apparatus for enabling a variety of different interfaces from various consumer electronic devices to communicate with an application.

Direct communication from one device to another enables a variety of features such as instant messaging, content distribution, and special community features. In one embodiment, content distribution involves the distribution of content directly from one consumer to another consumer through a peer device. In one embodiment, special community features include features such as recommendations, collaborative filtering, and affinity matching.

In one embodiment, the invention streamlines the integration of peer to peer functionality into content-based services and applications by utilizing plug-ins. In one embodiment, the plug-in encapsulates an existing peer to peer protocol and expresses it via high-level interfaces that can be accessed by applications. For example, an existing peer to peer protocol may include a file sharing protocol or an instant messaging protocol.

In one embodiment, the plug-ins also insulate developers from specific peer to peer protocols. According to one embodiment of the invention, the interfaces are designed to be protocol-agnostic and allow developers to easily switch protocols, to build protocol bridges, or to build “multi-headed” clients while using a common interface core on the peer devices.

In one embodiment, the invention is capable of integrating multiple functionalities such as content, communication and community within a peer device.

With respect to content, peer to peer content distribution allows content to be obtained from peer devices in addition to central content servers. Peer to peer distribution may result in reduced costs to the service provider and also improved response for consumers. When coupled with communication and community, the ability to move content directly between peer devices gives the basis of the viral-like form of content distribution known as superdistribution and content distribution networking.

With respect to communication, instant messaging, voice over IP and other types of real-time communication may rely on peer-to-peer connectivity. Some instant messaging systems use proprietary protocols. In one embodiment, the invention provides multi-headed clients to bridge the different propriety instant messaging systems on a single peer device.

With respect to community, various features may tend to have interfaces which are proprietary and application specific. The various features include special interest groups, collaborative filtering (e.g., using group ratings to help find content), affinity matching (e.g., matching users based on preferences), playlist sharing, and sending and receiving recommendations.

In one embodiment, the invention supports proprietary or specialized interfaces to communicate with the various applications and/or services as well standardized interfaces to communicate with other peer devices.

Those skilled in the art will recognize that many other implementations are possible, consistent with the present invention.

A. Environment and Architecture

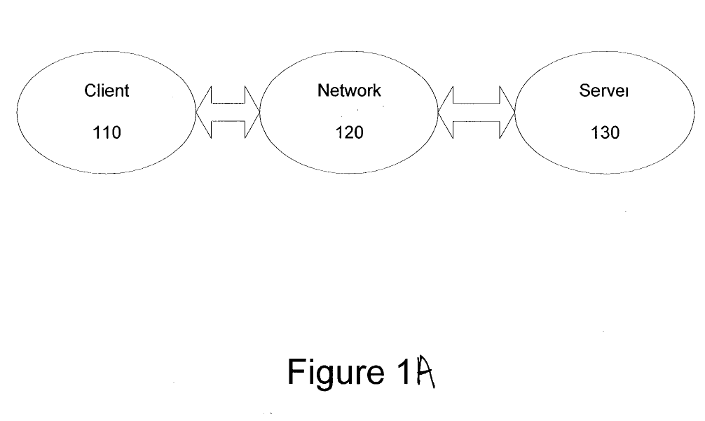

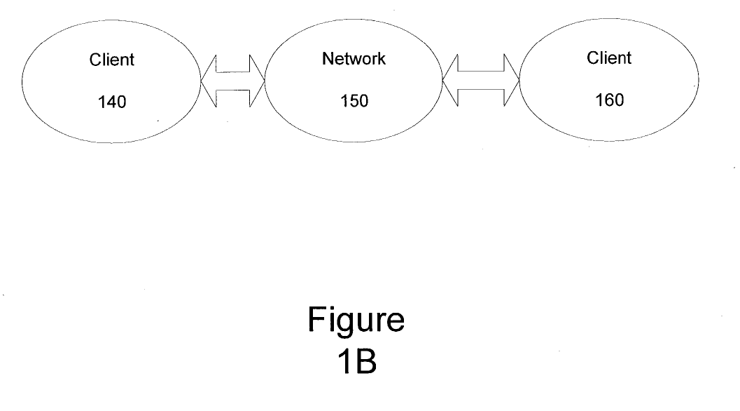

FIG. 1A is a diagram illustrating an environment within which the invention may be implemented. The environment includes a client 110, a network 120, and a server 130.

The client 110 may be a consumer electronics device. The consumer electronics device includes an interface framework which allows the unique interface protocol of the electronics device to seamless communicate with the server 130. Specifics of the interface framework are discussed below.

The network 120 interfaces with both the client 110 and the server 130. In one embodiment, the network 120 is the Internet. In another embodiment, the network 120 may be any transmission medium between the client 110 and the server 130.

The sever 130 is a device configured to interface with the client 110 through the network 120.

The client 110 and/or the server 130 may include a combination of software, hardware, and/or firmware to provide customized financing applications.

FIG. 1B is a diagram illustrating an environment within which the invention may be implemented. The environment includes a client 140, a network 150, and a client 160.

The clients 140 and 160 may be a consumer electronics device. The consumer electronics device includes an interface framework which allows the the clients 140 and 160 to seamlessly communicate with each other through a common set of protocols. Specifics of the interface framework are discussed below.

The network 150 interfaces with both the client 140 and the client 160. In one embodiment, the network 150 is the Internet. In another embodiment, the network 150 may be any transmission medium between the client 140 and the client 160.

The client 140 and/or the client 160 may include a combination of software, hardware, and/or firmware to provide the interface framework.

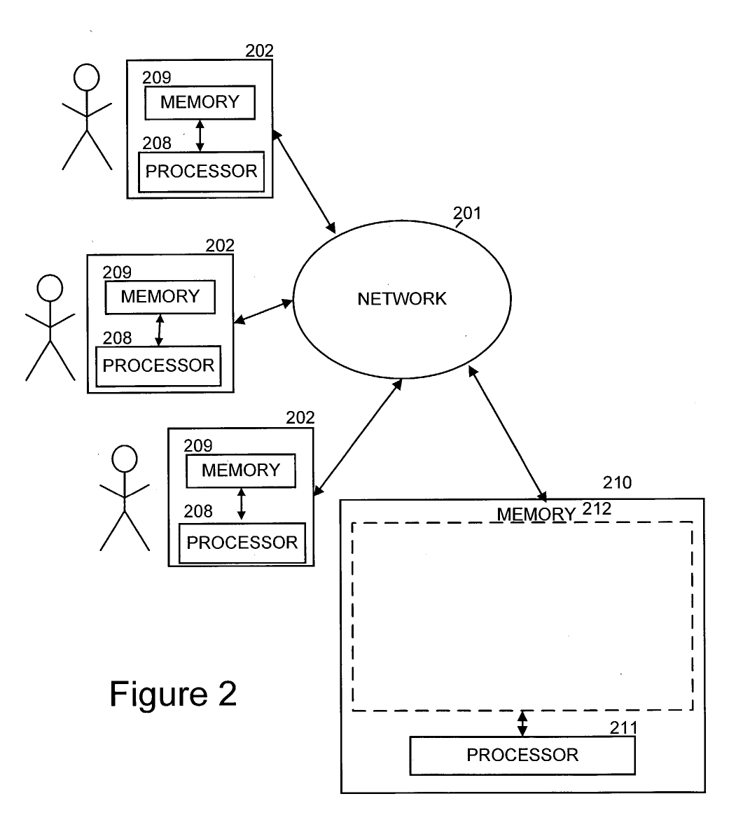

FIG. 2 is a simplified diagram illustrating an exemplary architecture in which the present invention may be implemented. The exemplary architecture includes a plurality of client devices 202, a server device 210, and a network 201. In one embodiment, the network 201 may be the Internet. The plurality of client devices 202 are each configured to include a computer-readable medium 209, such as random access memory, coupled to a processor 208. Processor 208 executes program instructions stored in the computer-readable medium 209. In another embodiment, the plurality of client devices 202 may also include a number of additional external or internal devices, such as, without limitation, a mouse, a CD-ROM, a keyboard, and a display.

The interface framework may be stored on the plurality of client devices 202 within each computer-readable medium 209.

Similar to the plurality of client devices 202, the server device 210 may include a processor 211 coupled to a computer-readable medium 212. The server device 210 may also include a number of additional external or internal devices, such as, without limitation, a secondary storage element, such as database 240.

The interface framework may be stored on the server device 210 within each computer-readable medium 212.

The plurality of client processors 208 and the server processor 211 can be any of a number of well known computer processors, such as processors from Intel Corporation, of Santa Clara, Calif. In general, the plurality of client devices 202 may be any type of computing platform connected to a network and that interacts with application programs, such as a digital assistant or a “smart” cellular telephone or pager. The server 210, although depicted as a single computer system, may be implemented as a network of computer processors.

The plurality of client devices 202 and the server 210 may include the interface framework. In one embodiment, the plurality of computer-readable medium 209 and 212 may contain, in part, the interface framework. Additionally, the plurality of client devices 202 and the server 210 are configured to receive and transmit electronic messages for use with the interface framework. Similarly, the network 201 is configured to transmit electronic messages for use with the interface framework.

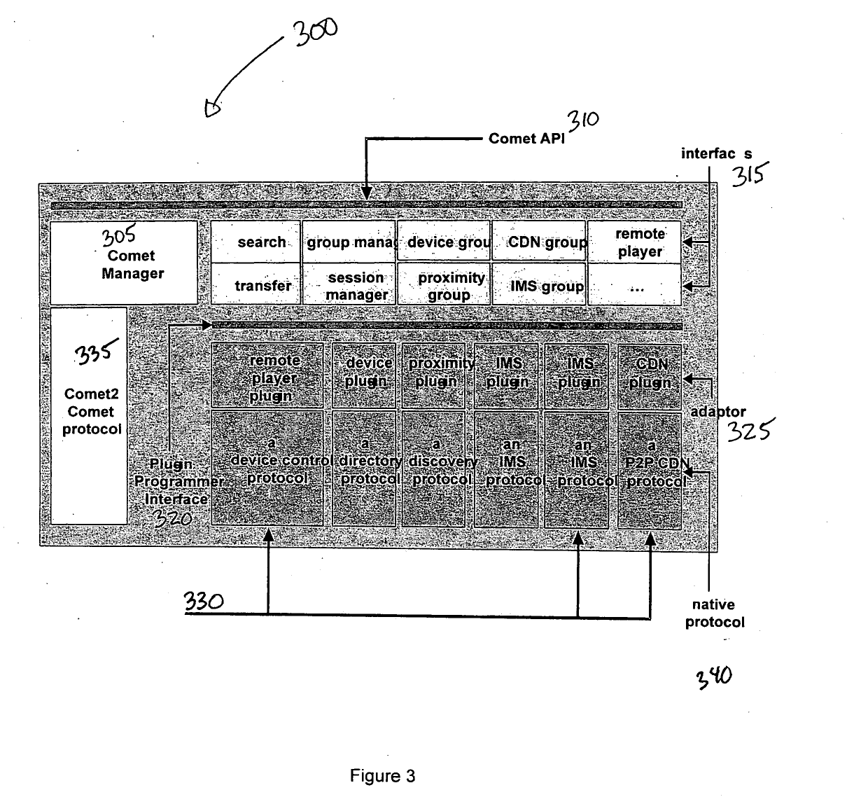

FIG. 3 illustrates one embodiment of an interface framework 300. The interface framework 300 includes a manager 305, a framework application program interface 310, a plurality of interfaces 315, a plug-in programmer interface 320, a plurality of plug-ins 330, and a framework protocol 335.

In one embodiment, the manager 305 is configured to coordinate tasks, requests and communications between the framework application program interface 310, the plurality of interfaces 315, the plug-in programmer interface 320, the plurality of plug-ins 330, and the framework protocol 335.

In one embodiment, the manager 305 is configured to install, configure, and run the plurality of plug-ins 330. In one embodiment, the manager 305 also utilizes the framework protocol 335 to communicate with the interface framework 300 running on other devices. In one embodiment, the framework protocol 335 allows one device with the interface framework 300 to determine specific plug-ins which are installed on another device with the interface framework 300.

In one embodiment, the framework application program interface 310 is configured to communicate between the interface framework 300 and a device such as a consumer electronic device.

In one embodiment, the plurality of interfaces 315 are configured to be utilized by various applications for accessing the functionality of the plurality of plug-ins 330. In one embodiment, the plurality of interfaces 315 may include the functions of search, transfer, group manager, session manager, device group, proximity group, content distribution network group, instant messaging group, remote player, and the like.

In one embodiment, the plug-in programmer interface 320 is configured to communicate between the plurality of interfaces 315 and the plurality of plug-ins 330.

In one embodiment, each the plurality of plug-ins 330 implements a particular peer to peer protocol. For example, a plug-in may be configured to implement the distribution protocol such as the Napster protocol, or the Gnutella protocol in one embodiment. In another embodiment, a plug-in may be configured to implement a peer to peer content distribution network.

In one embodiment, the plurality of plug-ins 330 includes a plurality of adaptors 325 and a plurality of native protocols 340. Each of the plurality of adaptors 325 is configured to integrate a corresponding one of the plurality of native protocols 340 into the interface framework 300.

In one embodiment, the plurality of adapters 325 include a remote player plug-in, a device plug-in, a proximity plug-in, an instant messaging plug-in, a content distribution network plug-in, and the like.

In one embodiment, the plurality of native protocols 340 is configured to correspond with an adaptor. For example, a device control protocol is an exemplary native protocol 340 which corresponds with the remote player plug-in. A directory protocol is an exemplary native protocol 340 which corresponds with the device plug-in. A discovery protocol is an exemplary native protocol 340 which corresponds with the proximity plug-in. An instant messaging protocol is an exemplary native protocol 340 which corresponds with the instant messaging plug-in. A peer to peer content distribution network protocol is an exemplary native protocol 340 which corresponds with the content distribution network plug-in.

In one embodiment, the plug-in programmer interface 320 is utilized to access both internal functionality and external functionality of the interface framework 300 to develop the plurality of adaptors 325.

In one embodiment, the plurality of plug-ins 330 provide functionality to applications outside the interface framework 300 via the plurality of interfaces 315. In one embodiment, the plurality of interfaces 315 are defined by the interface framework 300 and implemented by the plurality of plug-ins 330.

In one embodiment, the plurality of plug-ins 330 are configured to provide developers with a set of high-level application program interfaces. In one embodiment, developers are not concerned with the details of the underlying protocols and can easily add functionality to their applications by use of the plurality of plug-ins 330.

The specific plurality of interfaces 315, plurality of adaptors 325, plurality of native protocols 340 are shown for exemplary purposes and are not intended to limit the invention. Similarly, various elements are shown included within the interface framework 300 for exemplary purposes; additional elements may be added, elements may be deleted, and elements may be combined without departing from the scope of the invention.

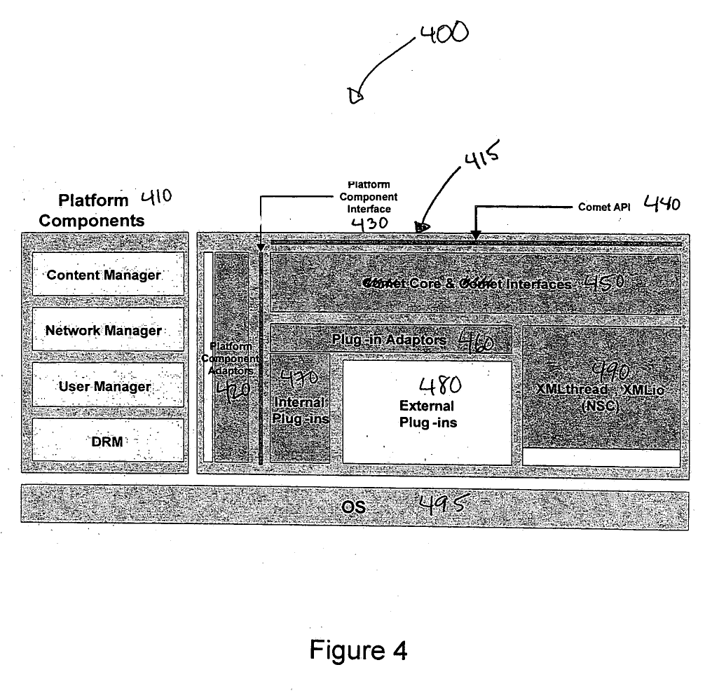

FIG. 4 illustrates one embodiment of a system 400. The system 400 includes platform components 410, an interface framework 415, and an operating system 495. The system 400 illustrates one embodiment of the interface framework 415 communicating with external components such as the platform components 410. In one embodiment, the platform components 410 may include a content manager, a network manager, a user manager, and a digital rights manager.

In one embodiment, the interface framework 415 includes a platform component adaptor 420, a platform component interface 430, an interface framework applications program interface 440, a core module 450, a plurality of plug-in adaptors 460, a plurality of internal plug-ins 470, a plurality of external plug-ins 480, and an XML module 490.

In one embodiment, the plurality of plug-ins 470 and 480 may need to access the platform components 410. To facilitate access to the platform components 410, the platform component interface 430 is utilized to encapsulate the components within the platform components 410.

In one embodiment, a portion of the platform component adaptor 420, the platform component interface 430, the interface framework applications program interface 440, the core module 450, the plurality of plug-in adaptors 460, the plurality of internal plug-ins 470, and a portion of the XML module 490 are platform independent. In one embodiment, portion of the platform component adaptor 420, the plurality of external plug-ins 480, and a portion of the XML module 490 are implemented for specific platforms. For example, the plurality of external plug-ins 480 are developed independently of the interface framework 415 and later integrated within the interface framework 415. In one embodiment, the plurality of internal plug-ins 470 are developed utilizing the tools within the interface framework 415.

In one embodiment, the platform component interface 430 increases the portability of the interface framework 415 by shielding the plurality of plug-ins 470 and 480 from changes to the platform components 410.

For example, the content manager within the platform components 410 which is utilized by a music jukebox application will likely differ from the content manager utilized by a video application. However in this example, both the music jukebox application and the video application may expose their unique content managers to one of the plurality of plug-ins 470 and 480 that would facilitate sharing the content from each respective content manager.

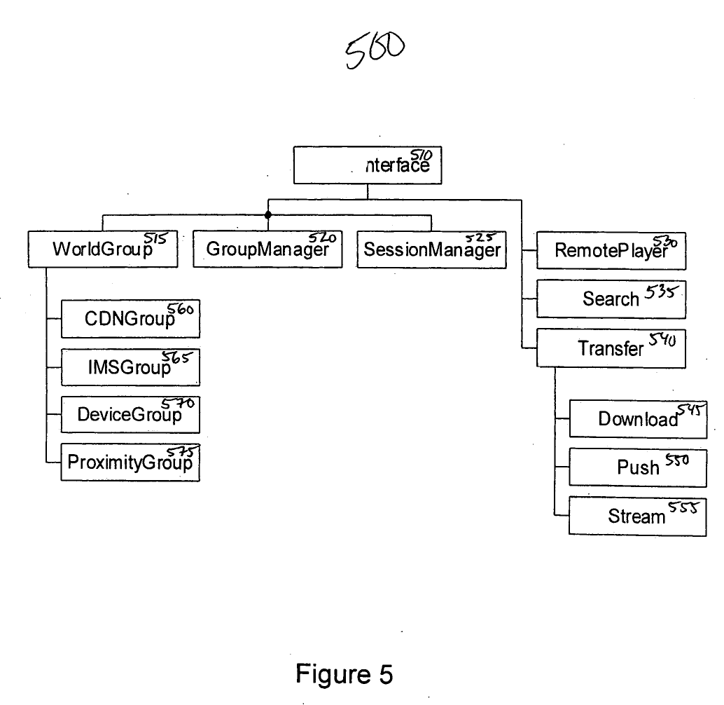

FIG. 5 illustrates an exemplary hierarchy of interface classes for a plug-in. In one embodiment, each plug-in has one or more interfaces. In one embodiment, each interface is derived from a framework interface 510.

In one embodiment, a worldgroup interface 515, a groupmanager interface 520, a sessionmanager interface 525, remoteplayer interface 530, search interface 535, and transfer interface 540 are specializations of the framework interface 510.

In one embodiment, the framework interface 510 comprises a base class for all interfaces within the interface framework. In one embodiment, the framework interface 510 obtains the interface identification from various interfaces. In one embodiment, each interface has a unique interface identification. In one embodiment, the framework interface is configured to register and unregister other interfaces and/or devices from monitoring events generated by a specific interface.

In one embodiment, the groupmanager interface 520 is configured to create new peer groups. In one embodiment, a peer group, is a set of peer devices with a common protocol. Peer groups may be configured to be usually persistent, that is, they continue to exist even if all members go offline.

The groupmanager interface 520 includes both advertised and private groups. Advertised groups are visible to other peer devices other than the creator of the group. In one embodiment, advertised groups are enabled by a mechanism for passing group descriptions between peer devices or by a centralized group registry. Private groups are configured to be visible to the creators of the peer group.

In one embodiment, application-defined peer groups may be created by the groupmanager interface 520 and are characterized by their membership policy. In one embodiment, there are two basic membership policies: a moderated group and a contact group. The moderated group is a peer group where members are invited to join by current members. The contact group is a peer group where members are added and removed by the peer that created the group. In addition to group creation, the groupmanager interface 520 may be used to advertise groups and handle group membership operations.

In one embodiment, the remoteplayer interface 530 is configured to obtain a content list information from remote content players and to discover what content is currently playing on a remote player. In one embodiment, a remote player may include a video player, a music player, a video game console, a computer, a cellular telephone, a pager, a personal digital assistant, and the like.

In one embodiment, the search interface 535 is configured to search for content on peer devices.

In one embodiment, the sessionmanager interface 525 is configured to create chat sessions for participants, invite participants to chat sessions, and send instant messages to peer devices.

In one embodiment, the transfer interface 540 is configured to transfer content between peer devices. The transfer interface 540 support specializations such as content download interface 545, push interface 550, and stream interface 555.

In one embodiment, the worldgroup interface 515 is configured to handle functions of peer groups. In one embodiment, each plug-in includes a world group interface 515. In one embodiment, the worldgroup interface 515 represents peer devices with which communication is possible via the plug-in. In another embodiment, the worldgroup interface 515 is also configured to determine the presence such as online/offline status of group members and to enumerate the group.

A contentdistributionnetwork interface 560 is a specialization of the worldgroup interface 515. In one embodiment, the contentdistributionnetwork interface 560 is configured to run a common peer to peer content distribution protocol for members.

An instantmessaging interface 565 is a specialization of the worldgroup interface 515. The instantmessaging interface 565 is configured to run a common instant messaging protocol for members.

A proximity interface 575 is a specialization of the worldgroup interface 515. The proximity interface 575 is configured to discover peers in their physical proximity. In one embodiment, the physical proximity may be adjusted based on the specific application.

A device interface 570 is a specialization of the worldgroup interface 515. The device interface 570 is configured to facilitate defined relationships between member of the group relative to a specific application and/or service. For example, one member may belong to a group owned by another member.

In another example, the proximity interface 575 for peer device A has X number of members in the proximity of the peer device A. Those X number of members are considered part of the worldgroup interface 515 belonging to the peer device A. The proximity interface 575 for a peer device B may differ, even if the peer device B is a member of the proximity interface 575 for the peer device A.

B. Operation

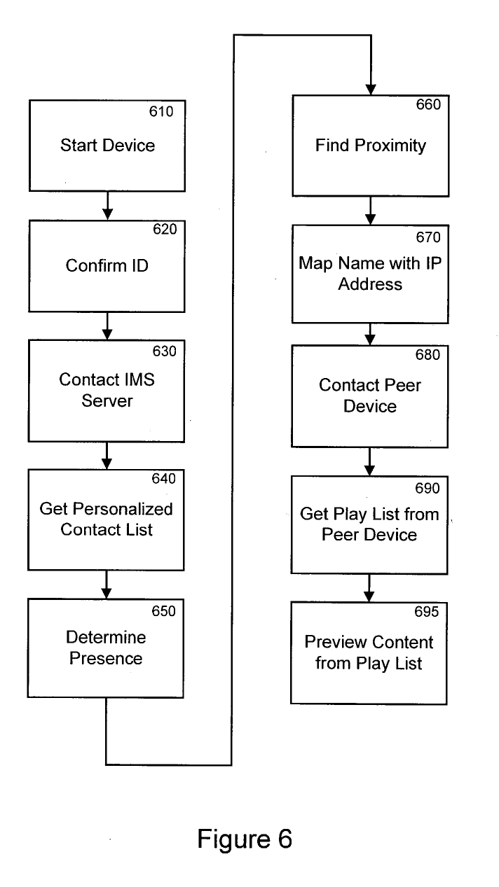

The flow diagram as depicted in FIG. 6 is merely one embodiment of the invention. The flow diagram in FIG. 6 is one particular use of the invention based on a specific application. In other embodiments, the invention may be utilized with other applications. The blocks within the flow diagram may be performed in a different sequence without departing from the spirit of the invention. Further, blocks may be deleted, added, or combined without departing from the spirit of the invention.

The flow diagram in FIG. 6 illustrates interactions with multiple devices utilizing the interface framework according to one embodiment.

In Block 610, a device operating the interface framework is initiated. In one embodiment, the device may be a media player. In another embodiment, the device may be a media player with a storage media for storing content.

In Block 620, a unique identification corresponding to the device is confirmed. In one embodiment, each device has an identification such as a serial number which uniquely identifies each device.

In Block 630, the device initiates contact with an instant messaging service.

In Block 640, the device receives a personalized contact list via the instant messaging service. The personalized contact list is unique to the device. In one embodiment, the personalized contact list contains information corresponding to contact information for individuals stored within the list. The personalized contact list is also known as a “buddy list”.

In Block 650, the device determines the presence of peer devices which correspond with individuals contained within the personalized contact list. For example, the peer devices corresponding to individuals within the personalized contact list may be “available”, “not on-line”, “busy”, and the like.

In Block 660, the device determines which other peer devices are in the proximity of the device. In one embodiment, the device searches for peer devices within a predetermined area that are identified with individuals within the personalized contact list. In another embodiment, the device searches for any peer device within a predetermined area of the device. The predetermined area may be defined and adjusted as needed.

In Block 670, the peer devices which correspond to individuals within the personalized contact list are mapped to a specific Internet Protocol address. In one embodiment, only peer devices which correspond to individuals that are “available” are mapped. In another embodiment, only peer devices which are within the proximity of the device are mapped.

In Block 680, the device contacts a peer device. In one embodiment, the device may contact a peer device which is within the proximity of the device. In another embodiment, the device may contact a peer device which is “available”.

In Block 690, the device obtains a play list from the peer device. In one embodiment, the play list includes a listing of content which is stored within the peer device. In another embodiment, the play list includes a listing of content which is available to the peer device.

In Block 695, the device previews content which is shown on the play list of the peer device. In one embodiment, the content is transmitted from the peer device to the device.

C. Conclusion

The foregoing descriptions of specific embodiments of the invention have been presented for purposes of illustration and description

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A method comprising:
communicating with a peer device via an interface framework; and
transmitting information between a first application on the peer device via a first plug-in wherein the first plug-in is compatible with the interface framework.

2. The method according to claim 1 wherein the peer device is a consumer electronics device.

3. The method according to claim 1 wherein the peer device is one of a cellular telephone, personal digital assistant, media player, pager, and personal computer.

4. The method according to claim 1 further comprising adding a second plug-in wherein the second plug-in allows a second application to communicate with the peer device.

5. The method according to claim 1 further comprising replacing the first plug-in with a new version of the first plug-in such that an updated version of the first application is compatible with the interface framework.

6. The method according to claim 1 further comprising translating an application command corresponding to the first application into an interface command corresponding to the standardized core interface.

7. The method according to claim 6 wherein translating occurs within the first plug-in.

8. The method according to claim 1 wherein the first plug-in comprises an adaptor and a native protocol.

9. The method according to claim 1 wherein the first application is an instant messaging application.

10. The method according to claim 1 wherein the first application is a content distribution network application.

11. The method according to claim 1 wherein the first application is a proximity application.

12. The method according to claim 1 wherein the first application is a search application.

13. An interface framework within a peer device, comprising:
an interface configured for communicating with the peer device;
a plug-in configured for communicating with the interface and an application,
wherein the plug-in is configured to translate requests from the application into a peer device request that is understood by the peer device.

14. The interface framework according to claim 13 further comprising an application program configured to transmit information between the peer device and the interface.

15. The interface framework according to claim 13 further comprising a plug-in program interface configured to transmit information between the plug-in and the interface.

16. The interface framework according to claim 13 further comprising a manager configured to coordinate operation between the plug-in and the interface.

17. The interface framework according to claim 13 wherein the plug-in comprises an adaptor and a native protocol.

18. The interface framework according to claim 13 wherein the plug-in is configured to be modifiable based on an updated version of the application.

19. The interface framework according to claim 13 wherein the peer device is configured to connect with a network.

20. The interface framework according to claim 13 wherein the peer device is one of a cellular telephone, personal digital assistant, media player, pager, and personal computer.

21. The interface framework according to claim 13 wherein the peer device is a consumer electronics device.

22. An interface framework within a peer device, comprising:
a plurality of interfaces configured for communicating with the peer device;
a plurality of plug-ins configured for communicating with a corresponding one of the plurality of interfaces and a corresponding one of a plurality of applications,
wherein the plurality of plug-ins are configured to translate requests from the plurality of applications, respectively, into a peer device request that is understood by the peer device.

23. The interface framework according to claim 22 further comprising a manager configured to coordinate operations between the peer device and the plurality of applications.

24. A computer-readable medium having computer executable instructions for performing a method comprising:
communicating with a peer device via a standardized core interface; and
transmitting information between a first application the peer device via a first plug-in wherein the first plug-in is compatible with the standardized core interface.

25. A system comprising:
means for communicating with a peer device via an interface framework; and
means for transmitting information between a first application on the peer device via a first plug-in wherein the first plug-in is compatible with the interface framework.
